(19) United States
(12) Patent Application Publication
(10) Pub. No.: US 2013/0082562 A1
(43) Pub. Date: Apr. 4, 2013

(54) SPINDLE MOTOR

(71) Applicant: SAMSUNG ELECTRO-MECHANICS CO., LTD., Gyunggi-do (KR)

(72) Inventor: Duck Young Kim, Gyunggi-do (KR)

(73) Assignee: SAMSUNG ELECTRO-MECHANICS CO., LTD., Gyunggi-do (KR)

(21) Appl. No.: 13/626,288

(22) Filed: Sep. 25, 2012

(30) Foreign Application Priority Data
Sep. 30, 2011 (KR) 10-2011-0100130

(51) Int. Cl. H02K 1/00

(52) U.S. Cl. 310/179

(57) ABSTRACT

Disclosed herein is a spindle motor including: a base; a sleeve fixedly coupled to an inner side of the base; a core coupled to an upper portion of the base and having a coil wound therearound; a shaft inserted into an inner diameter of the sleeve and rotatably mounted; a hub having the shaft coupled to a central portion thereof and having a magnet attached thereto, the magnet being formed to face the core; and a gas adsorbing part formed under the core so as to be spaced apart from the core. According to a preferred embodiment of the present invention, the gas adsorbing part is formed at an inner portion of the spindle motor to remove outgas that may be generated at the inner portion of the spindle motor, thereby making it possible to improve the performance and the operational reliability of the spindle motor.

### CROSS REFERENCE TO RELATED APPLICATION

This application claims the benefit of Korean Patent Application No. 10-2011-0100130, filed on Sep. 30, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

Generally, a spindle motor, which belongs to a brushless-DC motor (BLDC), has been widely used as a laser beam scanner motor for a laser printer, a motor for a floppy disk drive (FDD), a motor for an optical disk drive such as a compact disk (CD) or a digital versatile disk (DVD), or the like, in addition to a motor for a hard disk drive.

Recently, in a device such as a hard disk drive requiring high capacity and high speed driving force, in order to minimize generation of noise and non repeatable run out (NRRO), which is vibration generated at the time of use of a ball bearing, a spindle motor including a fluid dynamic bearing having lower driving friction as compared to an existing ball bearing has generally been used. In the fluid dynamic bearing, a thin oil film is basically formed between a rotor and a stator, such that the rotor and the stator are supported by pressure generated at the time of rotation. Therefore, the rotor and stator are not in contact with each other, such that frictional load is reduced. In the spindle motor using the fluid dynamic bearing, lubricating oil (hereinafter, referred to as an ‘operating fluid) maintains a shaft of the motor rotating a disk only with dynamic pressure (pressure returning oil pressure to the center by centrifugal force of the shaft). Therefore, the spindle motor using the fluid dynamic pressure bearing is distinguished from a ball bearing spindle motor in which the shaft is supported by a shaft ball made of iron.

In this spindle motor, outgas such as gas generated due to properties of various materials configuring internal components, residual gas due to cleaning of members, or the like, is generated. In addition, according to properties of adhesives used to couple between the rotor and the stator of the spindle motor or adhere a core of the motor, or the like, outgas is generated when the motor is exposed to a high temperature environment at the time of operation thereof Particularly, in the spindle motor using the fluid dynamic bearing, in the case of lubricating oil used as an operating fluid, various outgases such as gas that may be generated on a contact surface between the oil in a space in which the fluid dynamic bearing is formed and a motor member, gas that may be generated according to a material of a barrier film formed in order to block the operating fluid, or the like, of the fluid dynamic bearing, or the like, are generated, such that operational reliability of the motor is deteriorated. More specifically, when the outgas is attached to a recording disk, damage is caused in recording and reproducing information. Further, in the case of a magnetic disk, the outgas may invade a metal magnetic film or a magnetic film of a magnetic head formed on a surface of a disk and deteriorate recoding and reproducing capability.

### SUMMARY OF THE INVENTION

The present invention has been made in an effort to provide a spindle motor having a gas adsorbing part formed therein in order to remove outgas therein.

According to a preferred embodiment of the present invention, there is provided a spindle motor including: a base; a sleeve fixedly coupled to an inner side of the base; a core coupled to an upper portion of the base and having a coil wound therearound; a shaft inserted into an inner diameter of the sleeve and rotatably mounted; a hub having the shaft coupled to a central portion thereof and having a magnet attached thereto, the magnet being formed to face the core; and a gas adsorbing part formed under the core.

The gas adsorbing part may be spaced apart from the core and be formed in a ring shape on a surface of the base.

The gas adsorbing part may be made of an activated carbon, a ceramic a resin, or a combination thereof.

The gas adsorbing part may be coupled between a plurality of radial salient poles around which winding coils of the core are wound.

The gas adsorbing part may be made of an activated carbon, a ceramic, a resin, or a combination thereof.

The gas adsorbing part may be formed on one surface of the base corresponding to the coil and is made of an insulation material.

The gas adsorbing part may be made of an activated carbon, a ceramic, a resin, or a combination thereof.

### BRIEF DESCRIPTION OF THE DRAWINGS

FIG. 1 is a view of a spindle motor having a gas adsorbing part formed therein according to a first preferred embodiment of the present invention;

FIGS. 2A and 2B are, respectively, a view showing a spindle motor having a gas adsorbing part formed therein according to a second embodiment of the present invention and a plan view of a core having a gas adsorbing part coupled thereto according to the second preferred embodiment of the present invention; and

FIG. 3 is a view of a spindle motor having a gas adsorbing part formed therein according to a third preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In addition, the terms “first”, “second”, “one surface”, “the other surface” and so on are used to distinguish one element from another element, and the elements are not defined by the above terms. In describing the present invention, a detailed description of related known functions or configurations will be omitted so as not to obscure the gist of the present invention.

Hereinafter, preferred embodiments of the present invention will be described in detail with reference to the accompanying drawings.

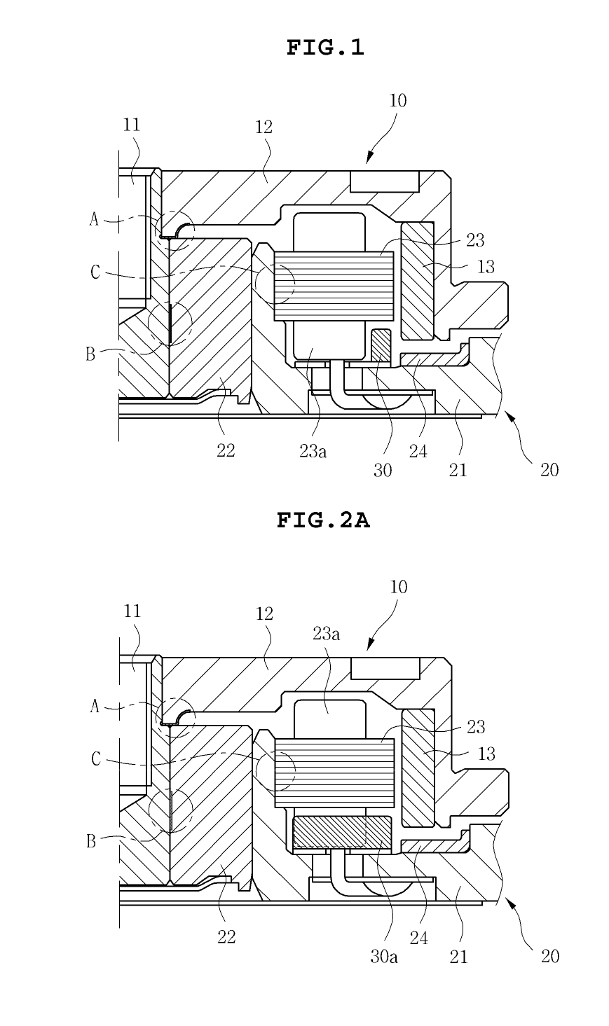

FIG. 1 is a view of a spindle motor having a gas adsorbing part 30 formed therein according to a first preferred embodiment of the present invention.

The spindle motor according to the first preferred embodiment of the present invention is configured to include a base 21, a sleeve 22 fixedly coupled to an inner side of the base 21, a core coupled to an upper portion of the base 21 and having a coil wound therearound, a shaft 11 inserted into an inner diameter of the sleeve 22 and rotatably mounted, a hub 12 having the shaft 11 coupled to a central portion thereof and having a magnet 13 attached thereto, the magnet 13 being formed to face the core, and a gas adsorbing part 30 spaced apart from a lower portion of the core 23 and formed in a ring shape on a surface of the base.

According to the preferred embodiment of the present invention, a thrust bearing part by a fluid dynamic bearing is formed at a portion at which the sleeve 22 and the shaft 11 contact each other in an axial direction. Here, the fluid dynamic bearing performs a lubricating action by injecting an operating fluid between two surfaces that relatively move to reduce friction or abrasion and generating pressure according to the shapes of the surfaces without pressure applied from the outside.

The fluid dynamic bearing is used, thereby making it possible to reduce friction force and power consumption at the time of rotation, as compared to the motor using a ball bearing. On the other hand, in the case of using the operating fluid, for example, oil, forming the fluid dynamic bearing, outgas may be generated on a contact surface between the oil and internal members of the motor. For example, the outgas may be generated in oil itself or on a contact surface (See portion B of FIG. 1) between the oil and the internal components of the motor due to a change in the surrounding environment such as a rise in temperature caused by high speed rotation of the motor.

Further, in the spindle motor including the fluid dynamic bearing, a bather film may be used in order to prevent leakage of the operating fluid forming the fluid dynamic bearing. The barrier film is formed on a contact surface between the sleeve 22 and the hub 12, thereby making it possible to prevent leakage of the operating fluid forming the fluid dynamic bearing (See portion A of FIG. 1). However, even in the case of the bather film, the outgas may also be generated due to a change in environment during operation of the motor.

Further, even in other spindle motors that do not use the fluid dynamic bearing, the outgas may also be generated due to adhesives used at the time of coupling of the internal components of the motor. For example, when the adhesive is formed on a coupling surface (See portion B of FIG. 1) on which the core 23 and the base 21 are coupled to each other or a coupling surface on which the rotor 10 and the stator 20 are press-fitted into and coupled to each other. In this case, the adhesive is exposed to a high temperature environment due to a rise in temperature at the time of rotation of the motor, such that the outgas having an effect on the operation of the motor may be generated.

Therefore, according to the preferred embodiment of the present invention, the gas adsorbing part 30 is formed at the inner portion of the motor in order to prevent an operational fault of the motor or prevent deterioration of operational reliability thereof due to the generation of the outgas caused by the configuration of the motor and the materials of the components of the motor.

The gas adsorbing part 30 is formed under the core 23, spaced apart from the core 23, and may have a ring shape. The gas adsorbing part 30 is formed on the surface of the base 21 corresponding to a lower side of the core 23 and is formed to be maximally spaced apart from the core 23, thereby making it possible to most effectively adsorb the outgas that may be generated by the operation of the spindle motor. That is, the outgas is generated to flow out toward an outermost direction of the core 23, thereby making it possible to remove a large amount of outgas by the gas adsorbing part 30 formed at this portion. A position of the gas adsorbing part 30 is not necessarily limited thereto. For example, the gas adsorbing part 30 is formed in a ring shape at an outermost side based on the shaft 11 of the motor, thereby making it possible to effectively adsorb the outgas as described above. The gas adsorbing part 30 is formed in the ring shape, thereby making it possible to increase an adsorbing area, but is not necessarily limited to being formed in the ring shape. It is obvious to those skilled in the art to change a design so as to form individual gas adsorbing parts 30 at appropriate positions.

Here, the gas adsorbing part 30 may be made of an activated carbon material or a porous material. Particularly, the porous material contains a ceramic, a resin, or the like. The gas adsorbing part 30 may be made of a material having an adsorbing property of the outgas according to the preferred embodiment of the present invention in addition to the above-mentioned material.

As described above, when the spindle motor is driven by the fluid dynamic bearing, the outgas is generated due to the operating fluid or due to the barrier film (not shown) or the material of the adhesive used to coupling of the motor or coupling of the internal components of the motor. The gas adsorbing part 30 according to the preferred embodiment of the present invention adsorbs the outgas that may be generated due to these various causes, thereby making it possible to improve operational performance of the motor and reliability of the operation.

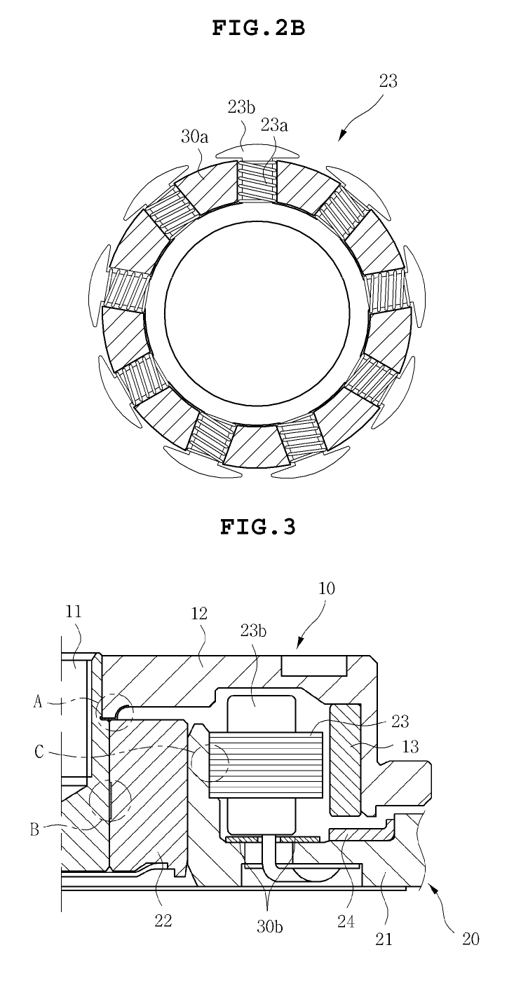

FIGS. 2A and 2B are, respectively, a view showing a spindle motor having a gas adsorbing part formed therein according to a second embodiment of the present invention and a plan view of a core having a gas adsorbing part coupled thereto according to the second preferred embodiment of the present invention.

The spindle motor according to the second preferred embodiment of the present invention is configured to include a base 21, a sleeve 22 fixedly coupled to an inner side of the base 21, a core 23 coupled to an upper portion of the base 21 and having a coil wound therearound, a shaft 11 inserted into an inner diameter of the sleeve 22 and rotatably mounted, a hub 12 having the shaft 11 coupled to a central portion thereof and having a magnet 13 attached thereto, the magnet 13 being formed to face the core 23, and gas adsorbing parts 30a coupled between a plurality of radial salient poles 23b around which winding coils 23a of the core 23 are wound.

Contents overlapped with the description of the spindle motor according to the first preferred embodiment of the present invention in a description of the spindle motor according to the second preferred embodiment of the present invention will be omitted. Hereinafter, a configuration position of the gas adsorbing part 30a different from that of the gas adsorbing part according to the first preferred embodiment of the present invention will be described.

The gas adsorbing parts 30a according to the second preferred embodiment of the present invention may be formed to be fitted into and coupled to each of spaces formed between the plurality of radial salient poles 23b of the core 23. The gas adsorbing parts 30a are formed to be complementary to a shape of the core 23, such that it may be simply coupled without performing a complicated process such as a bonding process. It is obvious to those skilled in the art that the gas adsorbing part 30a according to the present embodiment may be manufactured to have a shape complementary to the number and the shape of radial salient poles 23b of the core 23 through an appropriate design change. As shown in FIG. 2B, the gas adsorbing parts 30a are formed to correspond to spaced spaces between the radial salient poles 23b of the core 23, such that they may be simply fitted into and coupled to the spaced spaces. The respective gas adsorbing parts 30a coupled to the radial salient poles 23b of the core 23 may be manufactured integrally with each other by forming a gas adsorbing member having a ring shape on one surface thereof. Alternatively, the respective gas adsorbing parts 30a coupled between the radial salient poles 23b of the core 23 are individually manufactured, such that they may be coupled and used to the radial salient poles 23b of the core 23. The gas adsorbing parts 30a coupled between the radial salient poles 23b of the core 23 are formed, thereby making it possible to increase an adsorbing area according to the generation of the outgas. In addition, a separate adhesive is not used, thereby making it possible to prevent the generation of additional outgas in advance.

FIG. 3 is a view of a spindle motor having a gas adsorbing part 30b formed therein according to a third preferred embodiment of the present invention.

Contents overlapped with the description of the spindle motor according to the first preferred embodiment of the present invention in a description of the spindle motor according to the third preferred embodiment of the present invention will be omitted. Hereinafter, a configuration position of the gas adsorbing part 30b different from that of the gas adsorbing part according to the first preferred embodiment of the present invention will be described.

The gas adsorbing part 30b according to the third preferred embodiment of the present invention is formed on one surface of the base 21 corresponding to the coil 23a and is made of an insulation material. Since the coil 23a of the core 23 needs to be insulated from the base 21, an insulation sheet (not shown) may be formed. The gas adsorbing part 30b performing both of an insulation sheet function and a gas adsorbing function may be formed at a position at which the insulation sheet is formed. Therefore, a function of adsorbing outgas of the motor may be performed without forming a separate gas adsorbing part 30b.

Each of other components that are common to the spindle motors according to the first to third preferred embodiments of the present invention and an operational relationship therebetween will be described.

The spindle motor according to the preferred embodiment of the present invention is configured to include a rotor 10 and a stator 20. The rotor 10 includes the shaft 11 inserted into the inner diameter of the sleeve 22 and rotatably mounted and the hub 12 having the magnet 13 attached thereto, and the stator 20 includes the base 21, the sleeve 22, and the core 23 having the coil wound therearound. The stator 20 may further include a pulling plate 24.

The magnet 13 is coupled to the hub 12 at a position facing the core 23 coupled to the upper portion of the base 21. Here, the core 23 generates a magnetic field while forming a magnetic flux when current flows.

The magnet 13 formed at a position facing the core 23 includes repeatedly magnetized N and S poles to thereby form an electrode, corresponding to a variable electrode generated in the core 23. The core 23 and the magnet 13 generates repulsive force therebetween due to electromagnetic force by interlinking magnetic fluxes to rotate the hub 12 and the shaft 11 coupled to the hub 12, thereby driving the spindle motor.

In addition, the pulling plate 24 is fixed and coupled to the base 21 so as to correspond to the magnet 13 in an axial direction in order to prevent the rotor 10 from being floated at the time of driving of the motor. Attractive force acts between the pulling plate 24 and the magnet 13 to prevent abnormal floating of the rotor 10, thereby making it possible to stably drive the motor.

According to the preferred embodiments of the present invention, the gas adsorbing part is formed at the inner portion of the spindle motor to remove the outgas that may be generated at the inner portion of the spindle motor, thereby making it possible to improve the performance and the operational reliability of the spindle motor.

In addition, the gas adsorbing part is formed in the ring shape or a shape similar to the ring shape at the inner portion of the spindle motor to increase an adsorbing surface area of the gas adsorbing part, thereby making it possible to easily remove the outgas that may be generated at the inner portion of the spindle motor.

Further, the insulation sheet formed at the inner portion of the spindle motor in order to insulate the coil wound around the core from the base is replaced by the gas adsorbing part, thereby making it possible to reduce the outgas without forming a separate gas adsorbing part.

Furthermore, the outgas is removed by the gas adsorbing part according to the preferred embodiment of the present invention, thereby making it possible to improve durability of the surface of the member of the spindle motor and information reproducing performance of the recording/reproducing disk.

Although the preferred embodiments of the present invention have been disclosed for illustrative purposes, they are for specifically explaining the present invention and thus a spindle motor according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A spindle motor comprising:
a base;
a sleeve fixedly coupled to an inner side of the base;
a core coupled to an upper portion of the base and having a coil wound therearound;
a shaft inserted into an inner diameter of the sleeve and rotatably mounted;
a hub having the shaft coupled to a central portion thereof and having a magnet attached thereto, the magnet being formed to face the core; and
a gas adsorbing part formed under the core.

2. The spindle motor as set forth in claim 1, wherein the gas adsorbing part is spaced apart from the core and is formed in a ring shape on a surface of the base.

3. The spindle motor as set forth in claim 1, wherein the gas adsorbing part is made of an activated carbon, a ceramic, a resin, or a combination thereof.

4. The spindle motor as set forth in claim 1, wherein the gas adsorbing part is coupled between a plurality of radial salient poles around which winding coils of the core are wound.

5. The spindle motor as set forth in claim 4, wherein the gas adsorbing part is made of an activated carbon, a ceramic, a resin, or a combination thereof.

6. The spindle motor as set forth in claim 1, wherein the gas adsorbing part is formed on one surface of the base corresponding to the coil and is made of an insulation material.

7. The spindle motor as set forth in claim 6, wherein the gas adsorbing part is made of an activated carbon, a ceramic, a resin, or a combination thereof.
